(19) United States
(12) Patent Application Publication
(10) Pub. No.: US 2020/0043434 A1
(43) Pub. Date: Feb. 6, 2020

(54) LIQUID CRYSTAL PIXEL CIRCUIT, DRIVING METHOD THEREOF, AND LIQUID CRYSTAL DISPLAY PANEL

(71) Applicants: HKC Corporation Limited, Shenzhen City, Guangdong (CN); Chongqing HKC Optoelectronics Technology Co., Limited, Chongqing (CN)

(72) Inventor: Yu-Jen CHEN, Chongqing (CN)

(21) Appl. No.: 15/556,059

(22) PCT Filed: May 31, 2017
(86) PCT No.: PCT/CN2017/086642

§ 371 Date: Sep. 6, 2017

(30) Foreign Application Priority Data
May 5, 2017 (CN) 201710317446.0

(51) Int. Cl. G09G 3/36; G02F 1/1362

(52) U.S. Cl. CPC G09G 3/3688; G02F 1/136213; G09G 3/3655

(57) ABSTRACT

A liquid crystal pixel circuit includes a plurality of pixel units arranged in a matrix manner, each of the pixel is coupled to a corresponding data line and gate line. Each of the pixel unit includes a first switch component distributed in a domain of a main pixel, and a second switch component and a charge share switch distributed in a domain of a subpixel, the first switch component, the second switch component, and the charge share switch are electrically coupled to the data line and the gate line. A control end of the first switch component and a control end of the second switch component of the pixel unit in an (n+1)^{th} row and a control end of the charge share switch of the pixel unit in an n^{th} row are electrically coupled to an (n+1)^{th} gate line.

### BACKGROUND

### Technical Field

This application relates to a liquid crystal pixel circuit and a driving method thereof, and in particular, to a liquid crystal pixel circuit with a main pixel and a subpixel using a shared gate line, a driving method thereof, and a liquid crystal display panel.

### Related Art

For a liquid crystal display, a design manner of a charge sharing pixel is used sometimes to achieve a specification of a low color shift (LCS). In this manner, a plurality of capacitors in a pixel unit shares electric charges with each other. This is a derived technology for resolving a color shift problem.

In this design manner, the pixel unit is divided into two domains: a main pixel and a subpixel. The main pixel includes a first switch component, electrically coupled to a corresponding data line and gate charge line. The subpixel includes a second switch component and a charge share switch. The second switch component is electrically coupled to the corresponding data line and gate charge line. The charge sharing switch is further connected to a gate share line. The switch components are generally thin film transistor (TFT) components.

When the gate charge line is turned on, the first switch component and the second switch component charge the main pixel and the subpixel respectively. Then, the gate charge line is turned off, and the gate share line is turned on. In this case, the charge share switch is turned on to rearrange electric charges in a capacitor of the subpixel and electric charges in a sharing capacitor of the charge share switch, and to eventually reallocate potentials of the main pixel and the subpixel, thereby achieving an effect of an LCS.

In a general design, signal cabling of the gate charge line and signal cabling of the gate share line are separately controlled. For example, when a charge sharing function needs to be disabled, the gate share line may be turned off (for example, switched to a low voltage such as a VGL) to turn off the charge share switch.

However, this manner may approximately double quantities of used gate integrated circuits (ICs) and chips on flex (chips on film, COF). In addition, an area occupied by the gate share line is relatively large, and as a result, a pixel aperture ratio is further reduced.

### SUMMARY

To resolve the foregoing technical problems, objectives of this application are to provide a liquid crystal pixel circuit using a shared gate line and maintaining charge sharing, a driving method thereof, and a liquid crystal display panel.

To implement the objectives of this application and to resolve the technical problems of this application, the following technical solution is used for implementation. This application provides a liquid crystal pixel circuit, including: a plurality of pixel units arranged in a matrix manner, each of the pixel unit is coupled to a corresponding data line and gate line, and each of the pixel unit comprising: a main pixel, comprising: a first switch component, comprising a first channel end, a second channel end, and a control end, wherein the first channel end of the first switch component are electrically coupled to the data line, and the control end of the first switch component are electrically coupled to the gate line; and a first storage component, electrically coupled to the second channel end of the first switch component; and a subpixel, comprising: a second switch component, comprising a first channel end, a second channel end, and a control end, wherein the control end of the second switch component are electrically coupled to the gate line, and the first channel end of the second switch component are electrically coupled to the data line; a second storage component, electrically coupled to the second channel end of the second switch component; a charge share switch, comprising a first channel end, a second channel end, and a control end, the second channel end of the charge share switch are electrically coupled to the second channel end of the second switch component; and a third storage component, electrically coupled to the first channel end of the charge share switch, wherein the control end of the first switch component and the control end of the second switch component of the pixel unit in an (n+1)^{th} row and the control end of the charge share switch of the pixel unit in an n^{th} row are electrically coupled to an (n+1)^{th} gate line.

To resolve the technical problems of this application, the following technical measure may further be used for further implementation.

In an embodiment of this application, control signals provided by an n^{th} gate line and the (n+1)^{th} gate line are enabled within different time periods.

In an embodiment of this application, an n^{th} gate line is a gate charge line to provide a gate pulse signal, and the (n+1)^{th} gate line is a gate share line to provide a charge-sharing gate pulse signal.

In an embodiment of this application, pulse widths of the gate pulse signal and the charge-sharing gate pulse signal are equal.

In an embodiment of this application, the gate pulse signal precedes the charge-sharing gate pulse signal by one pulse width.

In an embodiment of this application, when the n^{th} gate line provides a gate pulse signal, the first switch component and the second switch component of the pixel unit in the n^{th} row are turned on, and the charge share switch of the pixel unit in the n^{th} row is turned off; when the n^{th} gate line is disabled and the (n+1)^{th} gate line provides a charge-sharing gate pulse signal, the charge share switch of the pixel unit in the n^{th} row is turned on; and when the (n+1)^{th} gate line provides a charge-sharing gate pulse signal after being disabled, the first switch component and the second switch component of the pixel unit in the (n+1)^{th} row are turned on, and the charge share switch of the pixel unit in the (n+1)^{th} row is turned off.

In an embodiment of this application, the first storage component comprises a first liquid crystal capacitor and a first storage capacitor, and the first storage component is connected between the second channel end of the first switch component and a common line (CL).

In an embodiment of this application, the second storage component comprises a second liquid crystal capacitor and a second storage capacitor, and the second storage component is connected between the second channel end of the second switch component and a CL.

In an embodiment of this application, the third storage component comprises a third storage capacitor, and the third storage component is connected between the first channel end of the charge share switch and a CL.

Another objective of this application is to provide a pixel driving method. Pixel units are arranged in a matrix manner, and each of the pixel unit is coupled to a corresponding data line and gate line. The pixel driving method includes: when an n^{th} gate line provides a gate pulse signal, turning on a first switch component and a second switch component of the pixel unit in an n^{th} row, and turning off a charge share switch of the pixel unit in the n^{th} row; when the n^{th} gate line is disabled, and an (n+1)^{th} gate line provides a charge-sharing gate pulse signal, turning on the charge share switch of the pixel unit in the n^{th} row; and when the (n+1)^{th} gate line provides a charge-sharing gate pulse signal after being disabled, turning on a first switch component and a second switch component of the pixel unit in an (n+1)^{th} row, and turning off a charge share switch of the pixel unit in the (n+1)^{th} h row.

Still another objective of this application provides a liquid crystal display panel, comprising: a first substrate; a second substrate; a liquid crystal layer, formed between the first substrate and the second substrate; and a liquid crystal pixel circuit, formed on the first substrate or the second substrate.

According to this application, a pixel cabling design is simplified in a charge sharing pixel design while maintaining charge sharing. Only one gate line is used to implement gate charging and gate charge sharing, thereby reducing quantities of used gate ICs and COFs and increasing a pixel aperture ratio. Next, this application may be applied to processes of various types of liquid crystal display panels, and has relatively high applicability.

### BRIEF DESCRIPTION OF THE DRAWINGS

FIG. 1a is a partial schematic structural diagram of an exemplary liquid crystal pixel circuit;

FIG. 1b is a schematic equivalent circuit diagram of a pixel unit of an exemplary liquid crystal pixel circuit;

FIG. 2a is a partial schematic structural diagram of a liquid crystal pixel circuit according to an embodiment of this application; and

FIG. 2b is a schematic equivalent circuit diagram of a pixel unit of a liquid crystal pixel circuit according to an embodiment of this application.

### DETAILED DESCRIPTION

The following embodiments are described with reference to the accompanying drawings, which are used to illustrate specific embodiments for implementation of this application. The directional terms such as “on”, “under”, “front”, “back”, “left”, “right”, “in”, “out”, and “side surface” mentioned in this application merely refer to directions as seen in the accompanying drawings. Therefore, the used directional terms are intended to describe and understand this application rather than to limit this application.

The accompanying drawings and the description are considered to be essentially descriptive rather than to be limitative. In the drawings, units with similar structures are represented by using a same reference number. In addition, for understanding and ease of description, the size and thickness of each component shown in the accompanying drawings are arbitrarily shown, but this application is not limited thereto.

In addition, in this specification, unless otherwise explicitly described to have an opposite meaning, the word “include” is understood as including the component but not excluding any other component. In addition, in this specification, “on” means that a component is located above or below a target component, but does not mean that the component needs to be located on the top based on the direction of gravity.

To further describe the technical means used in this application to achieve the intended inventive objectives and the effects thereof, specific implementations, structures, features, and effects of a liquid crystal pixel circuit, a driving method thereof, and a liquid crystal display panel provided according to this application are described in detail below with reference to the accompanying drawings and preferred embodiments.

In some embodiments, a liquid crystal display panel to which the liquid crystal pixel circuit in this application is applicable may be a wide-angle liquid crystal display panel.

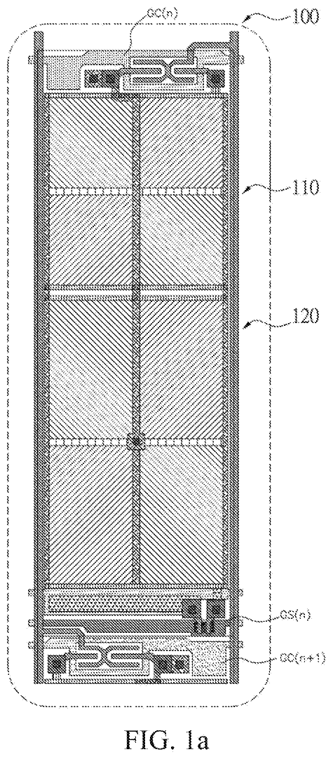

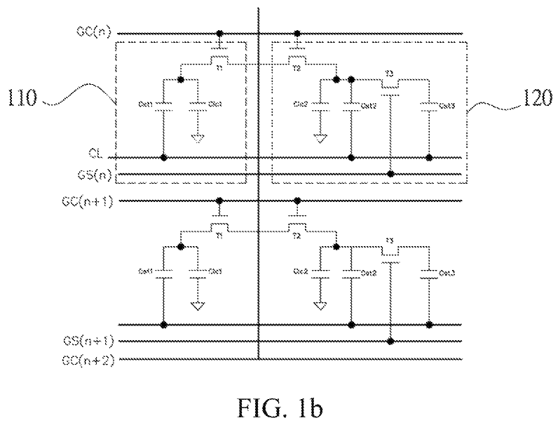

FIG. 1a is a partial schematic structural diagram of an exemplary liquid crystal pixel circuit, and FIG. 1b is a schematic equivalent circuit diagram of a pixel unit of an exemplary liquid crystal pixel circuit. As shown in FIG. 1a, for example, to increase a viewing angle, a pixel electrode is designed to have an eight-spoked-asterisk-shaped structure. The pixel electrode includes a strip-like vertical trunk and a strip-like horizontal trunk. The vertical trunk and the horizontal trunk perpendicularly intersect with each other at the center. The perpendicularly intersecting with each other at the center means that the vertical trunk and the horizontal trunk are perpendicular to each other, and equally divide the entire pixel electrode into four domains. Each pixel electrode domain is formed arranging strip-like slits having an angle of 45 degrees or 135 degrees from the vertical trunk or the horizontal trunk. The strip-like slits are located on a same plane as the vertical trunk and the horizontal trunk, so that the eight-spoked-asterisk-shaped structure of the pixel electrode in mirror symmetry in both horizontal and vertical directions shown in FIG. 1a is formed. For the eight-spoked-asterisk-shaped structure of the pixel electrode, because in each pixel electrode domain, an angle between a strip-like slit and the vertical trunk is the same as an angle between the strip-like slit and the horizontal trunk, a particular visual color difference or a visual color shift exists, and transmittance of a liquid crystal panel decreases. To improve the visual color difference or visual color shift, in the related art, one pixel unit is divided into two domains: a main pixel 110 and a subpixel 120. An independent electrode of the main pixel 110 is disposed in the domain of the main pixel 110, and an independent electrode of the subpixel 120 is disposed in the domain of the subpixel 120. Both the electrode of the main pixel 110 and the electrode of the subpixel are designed to have an eight-spoked-asterisk-shaped structure.

For the liquid crystal pixel circuit shown in FIG. 1b, for example, a design manner of a charge sharing pixel is used to achieve a specification of an LCS. In this design manner, the pixel unit is divided into two domains: a main pixel 110 and a subpixel 120. The main pixel 110 includes a first switch component T1, electrically coupled to a corresponding data line D(n) and gate charge line GC(n). The subpixel 120 includes a second switch component T2 and a charge share switch T3. The second switch component T2 is electrically coupled to the corresponding data line D(n) and gate charge line GC(n), and the charge share switch T3 is further connected to a gate share line GS(n). In some embodiments, the switch components are TFT components.

When the gate charge line GC(n) is turned on, the first switch component T1 and the second switch component T2 charge the main pixel 110 and the subpixel 120 respectively. The main pixel 110 uses, under the control of the gate charge line GC(n), the first switch component T1 to obtain data from the data line D(n) and saves the data in a storage capacitor Cst1. The subpixel 120 uses, similarly under the control of the gate charge line GC(n), the second switch component T2 to obtain data from the data line D(n) and saves the data in a storage capacitor Cst2. Then, the gate charge line GC(n) is turned off, and the gate share line GS(n) is turned on. The charge share switch T3 is turned on to rearrange electric charges in the storage capacitor Cst2 and in a liquid crystal capacitor Clc2 of the subpixel 120 and electric charges in a sharing capacitor Cst3 of the charge share switch T3. That is, the subpixel 120 uses, under the control of the gate share line GS(n), the charge share switch T3 to enable the storage capacitor Cst2 and the sharing capacitor Cst3 to share charges. According to such a structure, on the liquid crystal pixel circuit, a ratio of a voltage stored in the storage capacitor Cst1 to a voltage stored in the storage capacitor Cst2 may be properly controlled, so that a liquid crystal capacitor Clc1 and the liquid crystal capacitor Clc2 are driven by a default voltage, thereby eliminating a color shift problem during display. The foregoing descriptions are described only by using an example of a structure of a liquid crystal display panel to which the liquid crystal pixel circuit is applicable. The application scope of this application is not limited thereto, and may further be applied to various types of liquid crystal display panels.

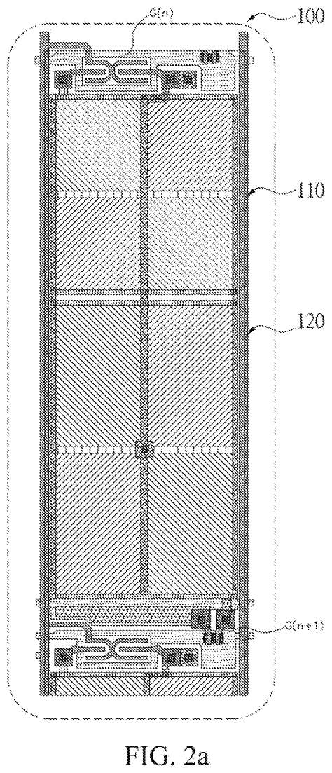

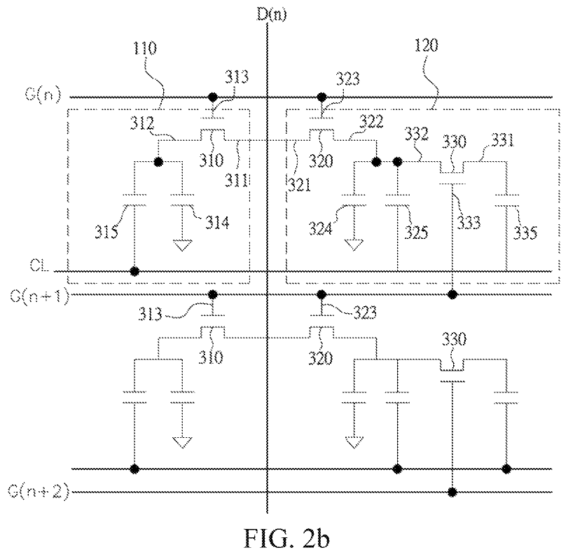

FIG. 2a is a partial schematic structural diagram of a liquid crystal pixel circuit according to an embodiment of this application, and FIG. 2b is a schematic equivalent circuit diagram of a pixel unit of a liquid crystal pixel circuit according to an embodiment of this application. Referring to FIG. 2a and FIG. 2b, in an embodiment of this application, a liquid crystal pixel circuit includes a plurality of pixel units arranged in a matrix manner. Each of the pixel unit 100 is coupled to a corresponding data line D(n) and gate line G(n), and each of the pixel unit 100 includes a main pixel 110 and a subpixel 120. The main pixel 110 includes: a first switch component 310, including a first channel end 311, a second channel end 312, and a control end 313, wherein the first channel end 311 of the first switch component 310 are electrically coupled to the data line D(n), and the control end 313 of the first switch component 310 are electrically coupled to the gate line G(n); and a first storage component, electrically coupled to the second channel end 312 of the first switch component 310. The subpixel 120 includes: a second switch component 320, including a first channel end 321, a second channel end 322, and a control end 323, wherein the control end 323 of the second switch component 320 are electrically coupled to the gate line G(n), and the first channel end 321 of the second switch component 320 are electrically coupled to the data line D(n); a second storage component, electrically coupled to the second channel end 322 of the second switch component 320; a charge share switch 330, including a first channel end 331, a second channel end 332, and a control end 333, the second channel end 332 of the charge share switch 330 are electrically coupled to the second channel end 322 of the second switch component 320; and a third storage component, electrically coupled to the first channel end 331 of the charge share switch 330. Wherein The control end 313 of the first switch component 310 and the control end 323 of the second switch component 320 of the pixel unit in an (n+1)^{th} row and the control end 333 of the charge share switch 330 of the pixel unit in an n^{th} row are electrically coupled to an (n+1)^{th} gate line G(n+1). That is, the (n+1)^{th} gate line G(n+1) is a gate share line GS of the pixel unit in the n^{th} row and a gate charge line GC of the pixel unit in the (n+1)^{th} row.

In an embodiment of this application, the first storage component includes a first liquid crystal capacitor 314 and a first storage capacitor 315, and the first storage component is connected between the second channel end 312 of the first switch component 310 and a CL.

In an embodiment of this application, the second storage component includes a second liquid crystal capacitor 324 and a second storage capacitor 325, and the second storage component is connected between the second channel end 322 of the second switch component 320 and a CL.

In an embodiment of this application, the third storage component includes a third storage capacitor 335, and the third storage component is connected between the first channel end 331 of the charge share switch 330 and a CL.

In an embodiment of this application, control signals provided by an n^{th} gate line G(n) and the (n+1)^{th} gate line G(n+1) are enabled within different time periods.

In an embodiment of this application, an n^{th} gate line G(n) is a gate charge line GC(n) to provide a gate pulse signal, and the (n+1)^{th} gate line G(n+1) is a gate share line GS(n) to provide a charge-sharing gate pulse signal.

In an embodiment of this application, pulse widths of the gate pulse signal and the charge-sharing gate pulse signal are equal.

In an embodiment of this application, the gate pulse signal precedes the charge-sharing gate pulse signal by one pulse width.

An embodiment of this application provides a pixel driving method. Pixel units 100 are arranged in a matrix manner, and each of the pixel unit 100 is coupled to a corresponding data line D(n) and gate line G(n). The pixel driving method includes:

when an n^{th} gate line G(n) provides a gate pulse signal, turning on a first switch component 310 and a second switch component 320 of the pixel unit in an n^{th} row, and turning off a charge share switch 330 of the pixel unit in the n^{th} row;

when the n^{th} gate line G(n) is disabled, and an (n+1)^{th} gate line G(n+1) provides a charge-sharing gate pulse signal, turning on the charge share switch 330 of the pixel unit in the n^{th} row; and

when the (n+1)^{th} gate line G(n+1) provides a charge-sharing gate pulse signal after being disabled, turning on a first switch component 310 and a second switch component 320 of the pixel unit in an (n+1)^{th} row, and turning off a charge share switch 330 of the pixel unit in the (n+1)^{th} row.

Still referring to FIG. 2a and FIG. 2b, in an embodiment, a liquid crystal display panel includes: a first substrate; a second substrate; a liquid crystal layer, formed between the first substrate and the second substrate; and the liquid crystal pixel circuit described above, formed on the first substrate or the second substrate.

In some embodiments, the liquid crystal pixel circuit may be applied to, for example, a curved display panel.

According to this application, a pixel cabling design is simplified in a charge sharing pixel design while maintaining charge sharing and without significantly changing a current production process. Only one gate line is used to implement gate charging and gate charge sharing, thereby reducing quantities of used gate ICs and COFs and increasing a pixel aperture ratio. Next, this application may be applied to processes of various types of liquid crystal display panels, and has relatively high applicability.

The terms such as “in some embodiments” and “in various embodiments” are repeatedly used. Usually, the terms do not refer to a same embodiment, but may also refer to a same embodiment. The terms such as “comprise”, “have”, and “include” are synonyms, unless other meanings are indicated in the context.

The foregoing descriptions are merely preferred embodiments of this application, but are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple alternation, equivalent change or modification made to the foregoing embodiments according to the technical essence of this application without departing from the content of the technical solutions of this application shall fall within the scope of the technical solutions of this application.

What is claimed is:

1. A liquid crystal pixel circuit, comprising:
a plurality of pixel units arranged in a matrix manner, wherein each of the pixel units is coupled to a corresponding data line and gate line, and each of the pixel unit comprising:
a main pixel, comprising:
a first switch component, comprising a first channel end, a second channel end, and a control end, wherein the first channel end of the first switch component are electrically coupled to the data line, and the control end of the first switch component are electrically coupled to the gate line; and
a first storage component, electrically coupled to the second channel end of the first switch component; and
a sub-pixel, comprising:
a second switch component, comprising a first channel end, a second channel end, and a control end, wherein the control end of the second switch component are electrically coupled to the gate line, and the first channel end of the second switch component are electrically coupled to the data line;
a second storage component, electrically coupled to the second channel end of the second switch component;
a charge share switch, comprising a first channel end, a second channel end, and a control end, wherein the second channel end of the charge share switch are electrically coupled to the second channel end of the second switch component; and
a third storage component, electrically coupled to the first channel end of the charge share switch,
wherein the control end of the first switch component and the control end of the second switch component of the pixel unit in an (n+1)^{th} row and the control end of the charge share switch of the pixel unit in an n^{th} row are electrically coupled to an (n+1)^{th} gate line.

2. The liquid crystal pixel circuit according to claim 1, wherein control signals provided by an n^{th} gate line and the (n+1)^{th} gate line are enabled within different time periods.

3. The liquid crystal pixel circuit according to claim 1, wherein an n^{th} gate line is a gate charge line to provide a gate pulse signal, and the (n+1)^{th} gate line is a gate share line to provide a charge-sharing gate pulse signal.

4. The liquid crystal pixel circuit according to claim 3, wherein pulse widths of the gate pulse signal and the charge-sharing gate pulse signal are equal.

5. The liquid crystal pixel circuit according to claim 3, wherein the gate pulse signal precedes the charge-sharing gate pulse signal by one pulse width.

6. The liquid crystal pixel circuit according to claim 3, wherein when the n^{th} gate line provides a gate pulse signal, the first switch component and the second switch component of the pixel unit in the n^{th} row are turned on, and the charge share switch of the pixel unit in the n^{th} row is turned off.

7. The liquid crystal pixel circuit according to claim 3, wherein when the n^{th} gate line is disabled and the (n+1)^{th} gate line provides a charge-sharing gate pulse signal, the charge share switch of the pixel unit in the n^{th} row is turned on.

8. The liquid crystal pixel circuit according to claim 3, wherein when the (n+1)^{th} gate line provides a charge-sharing gate pulse signal after being disabled, the first switch component and the second switch component of the pixel unit in the (n+1)^{th} row are turned on, and the charge share switch of the pixel unit in the (n+1)^{th} row is turned off.

9. The liquid crystal pixel circuit according to claim 1, wherein the first storage component comprises a first liquid crystal capacitor and a first storage capacitor, and the first storage component is connected between the second channel end of the first switch component and a common line (CL).

10. The liquid crystal pixel circuit according to claim 1, wherein the second storage component comprises a second liquid crystal capacitor and a second storage capacitor, and the second storage component is connected between the second channel end of the second switch component and a CL.

11. The liquid crystal pixel circuit according to claim 1, wherein the third storage component comprises a third storage capacitor, and the third storage component is connected between the first channel end of the charge share switch and a CL.

12. A pixel driving method, pixel units being arranged in a matrix manner, each of the pixel unit is coupled to a corresponding data line and gate line, and the pixel driving method comprising:
when an n^{th} gate line provides a gate pulse signal, turning on a first switch component and a second switch component of the pixel unit in an n^{th} row, and turning off a charge share switch of the pixel unit in the n^{th} row;
when the n^{th} gate line is disabled, and an (n+1)^{th} gate line provides a charge-sharing gate pulse signal, turning on the charge share switch of the pixel unit in the n^{th} row; and
when the (n+1)^{th} gate line provides a charge-sharing gate pulse signal after being disabled, turning on a first switch component and a second switch component of the pixel unit in an (n+1)^{th} row, and turning off a charge share switch of the pixel unit in the (n+1)^{th} row.

13. A liquid crystal display panel, comprising:
a first substrate;
a second substrate;
a liquid crystal layer, formed between the first substrate and the second substrate; and
a liquid crystal pixel circuit, comprising:
a plurality of pixel units arranged in a matrix manner, each of the pixel is coupled to a corresponding data line and gate line, and each of the pixel unit comprising:
a main pixel, comprising:
a first switch component, comprising a first channel end, a second channel end, and a control end, wherein the first channel end of the first switch component are electrically coupled to the data line, and the control end of the first switch component are electrically coupled to the gate line; and
a first storage component, electrically coupled to the second channel end of the first switch component; and
a subpixel, comprising:
a second switch component, comprising a first channel end, a second channel end, and a control end, wherein the control end of the second switch component are electrically coupled to the gate line, and the first channel end of the second switch component are electrically coupled to the data line;
a second storage component, electrically coupled to the second channel end of the second switch component;
a charge share switch, comprising a first channel end, a second channel end, and a control end, the second channel end of the charge share switch are electrically coupled to the second channel end of the second switch component; and
a third storage component, electrically coupled to the first channel end of the charge share switch,
wherein the control end of the first switch component and the control end of the second switch component of the pixel unit in an (n+1)^{th} row and the control end of the charge share switch of the pixel unit in an n^{th} row are electrically coupled to an (n+1)^{th} gate line; and
the liquid crystal pixel circuit being formed on the first substrate or the second substrate.

14. The liquid crystal display panel according to claim 13, wherein the first storage component comprises a first liquid crystal capacitor and a first storage capacitor, and the first storage component is connected between the second channel end of the first switch component and a common line (CL).

15. The liquid crystal display panel according to claim 13, wherein the second storage component comprises a second liquid crystal capacitor and a second storage capacitor, and the second storage component is connected between the second channel end of the second switch component and a CL.

16. The liquid crystal display panel according to claim 13, wherein the third storage component comprises a third storage capacitor, and the third storage component is connected between the first channel end of the charge share switch and a CL.
